(19) United States
(12) Patent Application Publication
(10) Pub. No.: US 2017/0350610 A1
(43) Pub. Date: Dec. 7, 2017

(54) A SYSTEM AND METHOD FOR CONTROL OF IN-DOOR VENTILATION

(71) Applicant: LEVIVENT AB, Stockholm (SE)

(72) Inventors: Wim MICHIELSEN, Stockholm (SE); Alexander KALM, Stockholm (SE)

(73) Assignee: LEVIVENT AB, Stockholm (SE)

(21) Appl. No.: 15/537,786

(22) PCT Filed: Nov. 30, 2015
(86) PCT No.: PCT/SE2015/051282

§ 371 Date: Jun. 19, 2017

(30) Foreign Application Priority Data
Dec. 22, 2014 (SE) 1451629-8

(51) Int. Cl. F24F 7/013; B01D 46/46; B01D 46/00; F24F 13/28; F24F 11/00

(52) U.S. Cl. CPC F24F 7/013; F24F 13/28; F24F 11/0079; F24F 11/006; F24F 11/0034; B01D 46/0043; F24F 11/0015; F24F 11/0012; F24F 11/0017; B01D 46/46; B01D 2279/35

(57) ABSTRACT

Disclosed is a system and method for control of in-door ventilation in a building having a series of rooms separated by walls. The system includes: at least one air treatment device arranged to treat the air; a plurality of fan units, including a fan and at least one sensor; and a central computing device adapted to collect data from the sensors and control the fans. Each wall is provided with an opening, the fan units are disposed in the openings to provide an air flow transporting air from the first room through the series of rooms to the last room and then back to the first room, and the air treatment device is disposed to treat the air.

### FIELD OF THE INVENTION

The present invention relates to a system and a method for control of in-door ventilation in a building having a series of rooms, the system comprising at least one air treatment device arranged to treat air in the building, a plurality of fan units, wherein each fan unit includes a fan and at least one sensor for sensing at least one property related to the quality of the air in the building, and a central computing device adapted to collect data from the sensors and to control the fans based on the collected data.

### BACKGROUND OF THE INVENTION

Arranging a system for purifying air in an existing building is a challenge. Usually, ventilation ducts are positioned on an attic or loft with openings into every room that needs to be ventilated, whereby the ducts are connected outside the rooms with a central ventilation apparatus that exchanges air inside the building with air from outside the building. A hole in the outside wall of the building needs to be made so that inside air can be exchanged with outside air. If no attic or loft is available, the ventilation ducts are positioned within the room of the building. The air is distributed to and from the rooms through these ducts by the ventilation apparatus. Fans may be placed in the ducts to help the flow of air to and from the central ventilation apparatus. Such ventilation systems are costly to install and operate. If air needs to be purified, usually a filter is placed in the ducts.

Alternatively, an air exchanger is built in one or more room of a building. For this, a hole in the outside wall in the room needs to be made so that inside air can be exchanged with outside air. Installing such a system is costly and even these air exchangers are costly to operate.

Most ventilation systems provide heating or cooling of air. If air also needs to be purified an air treatment device, such as an air handling unit, an air purifier or a filtering device can be positioned in such a ventilation system. Systems that only treat or purify air without heating or cooling a room are rare.

Further, most existing ventilation systems are adapted to ventilate one room. Even when ventilation ducts are used, the ventilation is still performed and controlled per room. In buildings that contain several rooms, such ventilation systems are expensive to install and expensive to operate. Especially when attics are not available, most ventilation systems reduce the attractiveness of the inside of the building because of the ventilation ducts that run through the building.

### OBJECT AND SUMMARY OF THE INVENTION

It is an object of the present invention to at least partly overcome the above mentioned problems, and to provide an improved system for control of in-door ventilation in a building having a plurality of rooms.

This object is achieved by a system as defined in claim 1.

The system is adapted for control of in-door ventilation in a building having a series of subsequent rooms separated by walls, whereby a first room and a last room in the series of rooms are separated by one of the walls. An example of a building may be an apartment with several rooms. The system comprises at least one air treatment device arranged to treat the air in the building. Examples of an air treatment device may be an air handling unit or an air purifier positioned in at least one of the rooms or a filtering device positioned in at least one of a plurality of fan units. The system comprises a plurality of fan units, wherein each fan unit includes a fan and at least one sensor for sensing at least one property related to the quality of the air in the building, and a central computing device, such as a server, adapted to collect data from the sensors and to control the fans based on the collected data. The connection between the server, the sensors, the air handling unit and the fans may be wired or wireless.

The system is characterized in that each of the walls in the building is provided with at least one opening, the fan units are disposed in the openings in the walls to provide an air flow between subsequent rooms through the openings, whereby the fans are arranged such that the air is transported from the first room through the series of rooms to the last room and then back to the first room, and the at least one air treatment device is disposed so that at least a part of the transported air is treated by the air treatment device.

A flow of air is generated by the fans or alternatively, also by the air purifier and pushed from one room to the next room. The air is being treated, cleaned or handled by the air treatment device(s).

One advantage of the new system is that air can be treated in multiple rooms by pushing or circulating air between rooms in a smart way. Air is being pushed from a first room to a second room and then to a third room and any subsequent room and then back to the first room. The walls may comprise at least one opening comprising one fan unit. Some walls in the building may have two fan units in order to circulate the air within the building.

In contrast to prior art systems, the ventilation system is not arranged per room using ventilation ducts that end in each room. No ducts run through the rooms or through an attic or loft above the rooms to and from a central distribution unit. Neither is any exchange needed with air outside the building. Therefore, no holes in walls to the outside of the building need to be drilled. The system of the invention can be relatively easy installed in existing buildings. In one embodiment, the system does not exchange air outside the building with air inside the building. Openings in a wall that separate rooms in a building may already exist for ventilation purposes. The housing of the fan unit can be positioned in the opening of the wall. Alternatively, a new hole in a wall can easily be made. The system of the invention does not require major adjustments to an existing architecture of a building.

The central computer (server) collects all data from all sensors inside the fan units and calculates the preferred settings for the fans. Controlling the fans can be performed using computer technology that is available or easy to set up.

Another advantage is that the temperature in a building will be more evenly distributed between the rooms of the building by the distribution of the air. Heating or cooling the building can thus be done more efficiently, which will save costs for heating or cooling.

In one embodiment, the at least one air treatment device is disposed in one of the rooms. In another embodiment, the at least one air treatment device comprises an air purifier arranged in one of the rooms. In one embodiment, the at least one air treatment device is disposed in at least one of the walls separating the rooms. In a further embodiment, the at least one air treatment device comprises a filtering device disposed in one of the fan units. In yet another embodiment, the air treatment device comprises a plurality of filtering devices and each of the fan units is provided with one of said filtering devices. Such filter devices or filters can be installed easily in or on the housing of the fan unit at low cost. Also the filters can be provided at low cost, such that each fan unit may comprise at least one filter.

An air purifier or a filtering device may be positioned in one of the rooms. Alternatively, more than one air purifier and/or more than one filtering devices may be used in the system of the invention. The air treatment device is preferably a stationary device. Depending on the capacity of the device, the volume of the building and the degree of pollution, one or more devices can be used in the system.

According to an embodiment of the invention, each fan unit comprises a tube shaped housing and the fan and the at least one sensor is positioned inside the housing. Such fan units are easy to manufacture at low costs. The housings can be manufactured at a factory and transported as a unit to the building prior to installation.

According to another embodiment of the invention, the at least one sensor is positioned on a side of the fan facing away from a side where air enters the fan unit. This improves the measurement of the quality or pollution in the air that is being distributed between the rooms through the building and therefore improves air handling or air purification in the building.

According to an embodiment of the invention, each wall that separates the rooms contains one fan unit.

According to an embodiment of the invention, the central computing device is adapted to control the speed of the fan based on the collected data.

According to a further embodiment of the invention, said fan is bidirectional and the central computing device is adapted to control the direction and speed of the fan based on the collected data. The quality of the air or the level of pollution may change over time in the different rooms. Therefore, the need for air handling or purification may alter per room and may change over time. Bidirectional fans and adaptable speeds improve the flexibility and adaptability of the system to the changes in air quality over time.

According to another embodiment of the invention, the at least one property of air is selected from the group comprising temperature, moisture, carbon monoxide, carbon dioxide, ozone, sulfur dioxide, nitrogen dioxide, smoke, soot, dust, seeds, plant spores, bacteria, fungi, mold, dust mite, smog and water.

According to an embodiment of the invention, the at least one sensor is adapted for sensing at least one property related to the quality of the air passing through the fan. Different sensors can be used in the system of the invention. In one embodiment, one or more fan units comprise one or more sensors. This way, more than one quality of air can be measured by the sensors to control different qualities of the air in the building.

According to an embodiment of the invention, at least one fan unit further comprises a motion sensor. The sensor is arranged to sense a motion in the room, where the sensor is positioned. A motion sensor may easily be positioned on or close to an edge of the housing adapted to sense motion in the room. Such motion sensor may be connected to the lighting or a sound system, such that light is turned on or a sound is produced upon the sensing of a motion in the room. The motion sensor may be controlled by the central computing device.

According to another embodiment of the invention, each fan unit comprises a radio unit adapted to communicate with the central computing device. The radio unit may also comprise a processor. Data collected from the sensors can be sent to the central computing device, which processes the data and in response sends a commando to the radio unit to control each individual fan. The system of the invention provides control of each fan individually through a central computing device. This improves the ventilation of the in-door air and optimizes the quality of the air in the building. This allows for so called fine tuning of the ventilation, which improves the efficiency of the system and reduces costs for the user.

The system of the invention may be controlled manually, e.g. by using potentiometers. Each fan unit may have an ON/OFF button. According to a further embodiment of the invention, the system operates continuously. Air purification is improved if air can be distributed through the building continuously. This prevents accumulation of pollution in one or more rooms in the building and thus improves the quality of the air inside the building at all times.

According to another embodiment of the invention, the air treatment device or air handling unit has a capacity to handle or clean a maximum volume of air and the number of air treatment devices in the building is adapted to the capacity of the devices and the pollution of the air to be purified. In one embodiment, one air treatment device, such as an air purifier is arranged in one of the rooms of the building. In another embodiment, more than one air treatment devices are arranged in one or more rooms of the building. The capacity of the air treatment device may differ and may for example depend on the quality and/or size of the device. The capacity is related to a volume of air that can be handled or cleaned by the device. The capacity of the air treatment device is further dependent on the circumstances, such as the level of pollution, in the building. If the volume of the building is larger than the volume that the air treatment device can handle effectively, an additional air treatment device can be installed and used in the system of the invention. A combination of air treatment devices can also be used, especially in cases where the level of pollution is too large to be effectively be purified by the air treatment device. In one embodiment, the system comprises one air purifier and one or more filtering devices.

In one embodiment, the fan and/or the at least one sensor in each fan unit can be turned on or off manually.

Another embodiment relates to a system for control of in-door ventilation in a building having a series of subsequent rooms separated by walls, and a first room and a last room in the series of rooms are separated by one of the walls, whereby the system comprises:
at least one air treatment device arranged to treat the air in the building,
a plurality of fan units, wherein each fan unit includes a fan, and
a central computing device adapted to control the fans, characterized in that each of the walls is provided with at least one opening, the fan units are disposed in the openings in the walls to provide an air flow between subsequent rooms through the openings, whereby the fans are arranged such that the air is transported from the first room through the series of rooms to the last room and then back to the first room, and the air treatment device is disposed so that at least a part of the transported air is treated by the air treatment device.

A further embodiment relates to a system for control of in-door ventilation in a building having a series of subsequent rooms separated by walls, and a first room and a last room in the series of rooms are separated by one of the walls, whereby the system comprises:
at least one air treatment device arranged to treat the air in the building, and
a plurality of fan units, wherein each fan unit includes a fan, characterized in that each of the walls is provided with at least one opening, the fan units are disposed in the openings in the walls to provide an air flow between subsequent rooms through the openings, whereby the fans are arranged such that the air is transported from the first room through the series of rooms to the last room and then back to the first room, and the air treatment device is disposed so that at least a part of the transported air is treated by the air treatment device.

In one embodiment, the fan in each fan unit can be turned on or off manually.

In a further embodiment, the invention relates to a system for control of in-door ventilation in a building having a plurality of rooms, whereby the system comprises:
at least one air handling unit or air purifier arranged in one of the rooms,
a plurality of fan units, wherein each fan unit includes a fan and at least one sensor for sensing a property related to the quality of the air in the building, and
a central computing device adapted to collect data from the sensors and to control the fans based on the collected data, characterized in that the fan units are arranged to transport air between the rooms so that the controlled fans distribute air from the at least one air handling unit to the multiple rooms of the building and back to the at least one air handling unit.

This object is also achieved by a method for treating in-door air in a building having a series of subsequent rooms separated by walls, and a first room and a last room in the series of rooms are separated by one of the walls, wherein the method comprises the steps of:
providing an air flow through the building from the first room through a series of subsequent rooms to the last room and back to the first room by means of fans disposed in at least one opening per wall,
treating the transported air to improve the quality of the air,
sensing at least one property related to the quality of the air in the openings in the walls,
collecting data from the at least one sensor disposed in the opening, and
controlling the air flow based on data collected by a central computing device.

In another embodiment, the invention relates to a method for handling or purifying air in a building having a plurality of rooms, wherein the method comprises the steps of
providing at least one air handling unit arranged in one of the rooms and providing a plurality of fan units, wherein each fan unit includes a fan and at least one sensor for sensing a property related to the quality of the air in the building, wherein the fan units are arranged to transport air between the rooms, and a central computing device adapted to collect data from the sensors and to control the fans based on the collected data, and
distributing air from the at least one air handling unit to the multiple rooms of the building and back to the at least one air handling unit so that handled or clean air is distributed from the air handling unit to the other rooms and air with low quality is distributed to the at least one air handling unit for handling or cleaning.

According to an embodiment of the method, the method is performed using the system as defined in any one of the embodiments above.

According to another embodiment of the method, the air treatment device or air handling unit is an air purifier.

Advantages of the method are apparent from the advantages described for the system.

### BRIEF DESCRIPTION OF THE DRAWINGS

The invention will now be explained more closely by the description of different embodiments of the invention and with reference to the appended figures.

FIG. 1 shows a system according to an embodiment of the invention.

FIG. 2 shows a schematic overview of the connections between the fan unit and a central computing device.

FIG. 3. shows a building in which experiment 1 has been conducted.

FIG. 4 shows a graph from results obtained in experiment 1.

### DETAILED DESCRIPTION OF PREFERRED EMBODIMENTS OF THE INVENTION

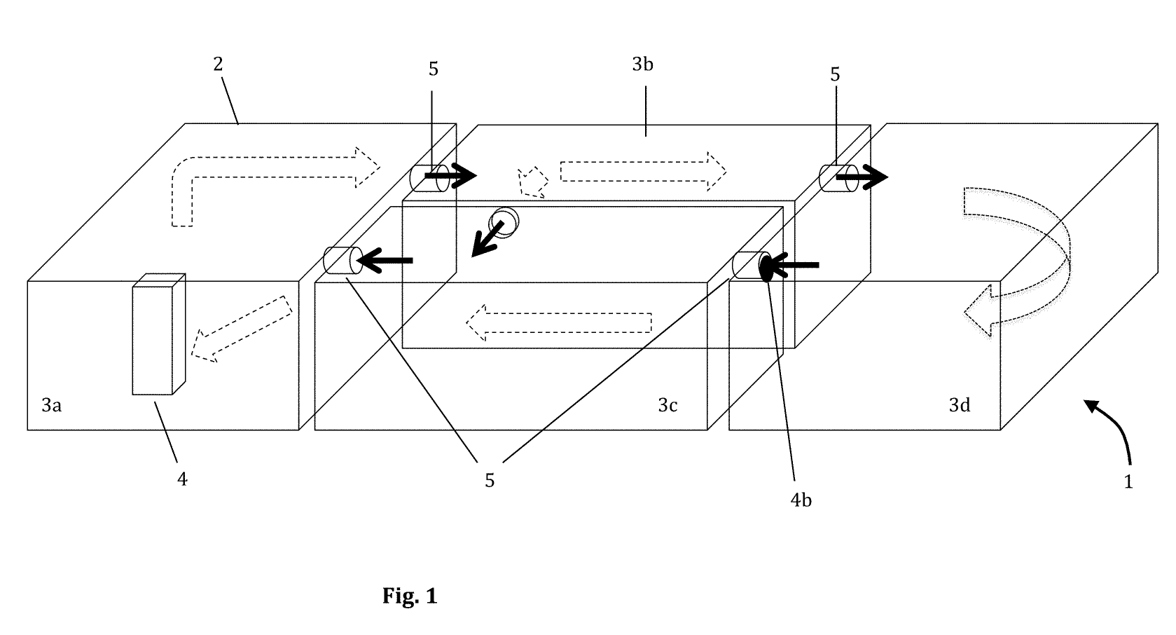

FIG. 1 shows a system 1 for control of in-door ventilation in a building 2. The building may be any building having one or more floors. The building may be an apartment having one floor. The building has a plurality of rooms 3a-3e. As shown in FIG. 1, the building may have a series of rooms, whereby the rooms are separated by walls. The term “room” encompasses any enclosure in the building, such as hallway, kitchen, closest, and the like. The system comprises at least one air treatment device (4).

The air treatment device may be an air handling unit 4a arranged in one of the rooms 3. An air handling unit may be defined as an apparatus capable of treating air by sucking in air at one end, treating the air, e.g. using filters, and blowing out or dissipating the air at a second end of the apparatus. The air handling unit 4a may be an air purifier 4a. Normally, the air handling unit has a capacity to treat a certain maximum volume of air. The number of air handling units in the building can be adapted to the capacity of the air handling unit and/or to the quality or pollution of the air to be handled or purified. Examples of air handling units or air purifiers that can be used in the system 1 of the invention are manufactured by BlueAir, Honeywell, Whirlpool and Alen.

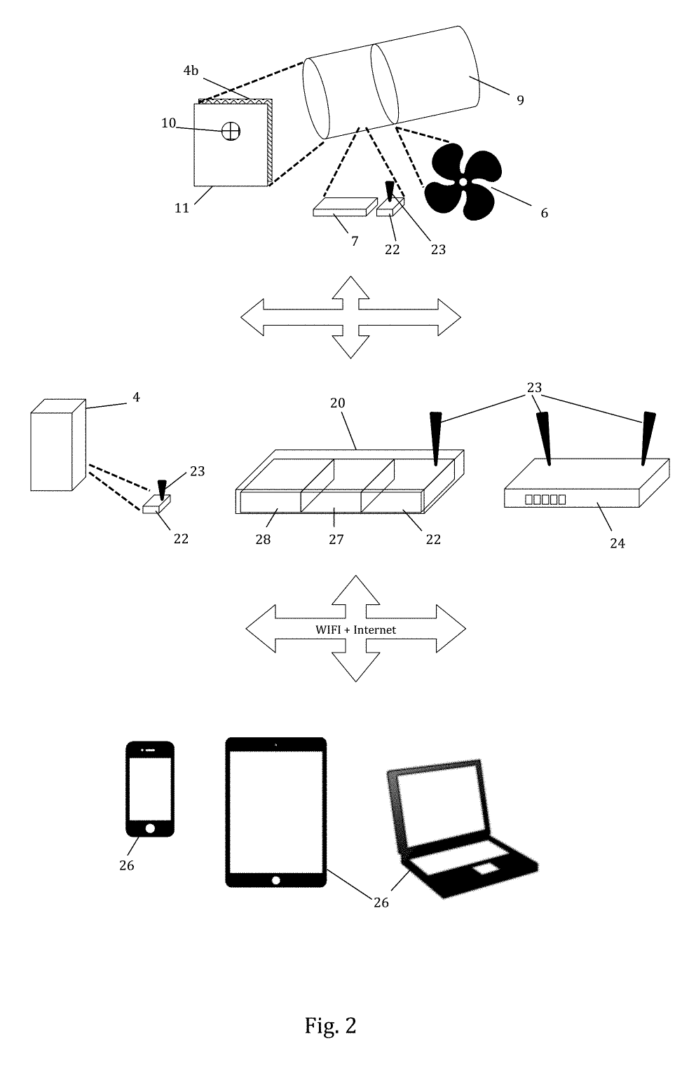

The air treatment device may be a filtering device or filter 4b. The filter is arranged in a fan unit 5 as shown in FIG. 2. One or more fan units may comprise one or more filters.

Preferably, each fan unit comprises one filter 4b. Suitable filters are filters capable of filtering particles at a size between 1 pm to 10 mm, or 1 nm to 2500 μm, or 100 nm to 5000 μm.

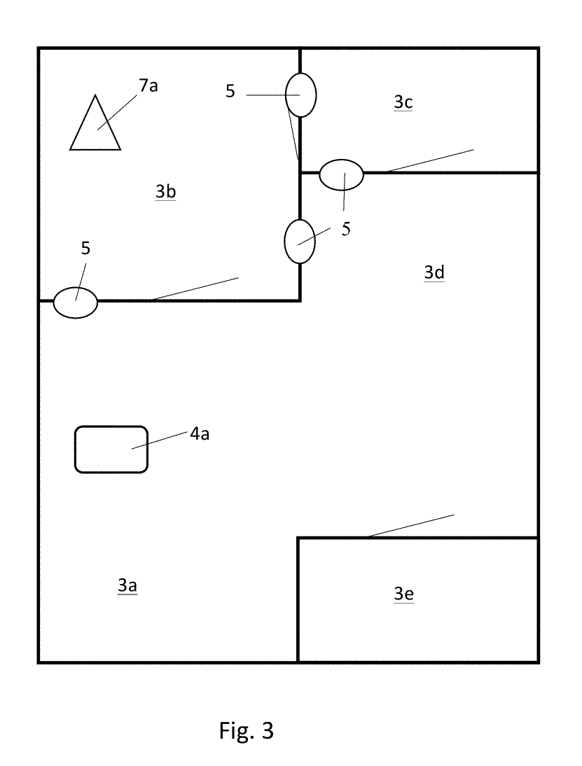

The system comprises a plurality of fan units 5. The units are arranged between the rooms 3 as shown in FIGS. 1 and 3. The fan units are positioned in openings in walls that separate the rooms 3. The fan units 5 can be positioned in such a way that an air flow, (indicated by the arrows in FIG. 1) is created inside the building. From a first room 3a, the air is pushed by the fans and/or the air handling unit to a second room and from there to a third and then to any subsequent room to a last room. From the last room in the series of rooms, the air is pushed back to the first room. The first and the last room are thus separated by a wall and connected through a fan unit present in said wall. In one embodiment, each wall has one opening. In another embodiment, each wall has one or more openings, such as one, two, three or four openings, whereby the walls comprising more than one opening separate more than one adjacent room. As shown in FIG. 3, room 3b comprises three openings, one between room 3a and room 3b, one between room 3b and room 3c and one between room 3b and room 3d. One of the walls in room 3b thus comprises two openings that connect room 3b to two different rooms, namely room 3c and room 3d. Each opening comprises a fan unit.

The flow of air passes the at least one air treatment device, where the air is being treated, handled, purified or cleaned. The terms “handle, handling, handled”, “clean, cleaning, cleaned”, “purify, purifying, purified”, “treat”, “treating”, “treated” means removal of properties in air. The terms “treated air”, “clean air”, “handled air” or “purified air” means air comprising an air property (e.g. a level of pollution) below a predetermined level. The term “air with low quality” means air comprising an air quality at or above a predetermined level.

As shown in FIG. 2, each fan unit 5 includes a fan 6 and at least one sensor 7 for sensing at least one property related to the quality of the air in the building 2. The fan unit may comprise a tube shaped housing 9, whereby the fan 6 and the at least one sensor 7 are positioned inside the housing. The filter 4b may be positioned in the housing or on the front or back side of the housing. An at least partially air-permeable lock 11 may be used on one or both ends of the housing. One or more fans may be mono-directional or bi-directional. The sensor may be positioned on a side of the fan, where air has passed the fan. The sensors may be protected by a cover in order to protect the sensor from dust and moisture. One or more sensors, and one or more different sensors measuring one or more properties of air may be comprised in the housing of a fan unit 5. Further sensors may be present in the building outside the fan unit.

The fan unit may comprise a motion sensor 10 as shown in FIG. 2. Such a motion sensor may be connected to lighting in the room, such that light is turned ON upon sensing motion in the room and the light is turned OFF after a period without motion in the room. Likewise, the motion sensor may be connected to a sound or alarm device that makes a sound upon sensing motion in the room. The motion sensor may as well send a notice or alarm to the user of a smartphone, tablet and/or computer 26 as shown in FIG. 2.

The system may be handled manually or automatically. For manual handling a potentiometer could be used. The fan unit may comprise ON/OFF buttons for manual handling of the units. The sensors may also comprise ON/OFF buttons for manual handling of the sensors.

The operation of the system may be analogue, partially analogue or digital.

The rotation of the fan 6 is electronically controlled. The electrical power may be provided by an electrical cable connected to the electricity network of the building or a battery. The power and rotation speed of the fan is controlled by a central computing device or server 20. The server 20 also controls the direction of the fan 6.

The computing device 20 is also connected to the sensors 7 in the fan unit so that data from the sensors can be communicated to the computing device 20. This can for example be done using a radio unit 22. The radio units may support GHz or sub-GHz wireless communication and may be configured to use protocols like ZigBee, WiFi, Bluetooth, WoLAN, Z-wave, EnOcean, Thread, Echonet and Wi-SUN. As shown in FIG. 2, the server 20 may also be connected to and control the air handling unit 4a. The connection between the server 20, the air handling unit 4a, the fans 6 and the sensors 7 may be wired or wireless. Antennas 23 may be used for this connection. Modern systems may rely on standards-based multi-protocol heterogeneous networking, such as that specified in the IEEE 1905.1 standard and verified by the nVoy auditing mark. These accommodates typically use only IP-based networking but can make use of any existing wiring, and also integrate powerline networking over AC circuits, power over Ethernet low power DC circuits, low-bandwidth wireless network, such as ZigBee and Z-wave, high-bandwidth wireless networks, such as LTE and IEEE 802.11n and IEEE 802.11ac.

A router 24 may be used for wireless communication between the different parts of the system. The system 1 may comprise a computing device 26, such as a smartphone, a tablet and a computer, providing an interface with a user and comprising a display unit, such as a screen, and an input means, such as a keyboard. As shown in FIG. 2, the computing device 26 enables a user of the system to get information from the system and to control the system. An Application on a computing device 26 may be used for establishing a secure connection for the user to the server 20. The server 20 comprises a processing unit 27 for collecting and processing data from the sensors and a memory unit 28. The radio unit 22 as present in the fan unit 5 may also comprise a processor to collect and process data from the sensor or receive commands from the server 20. The radio unit 22 as present in the fan unit 5 may also comprise a memory unit 28 (not shown). Preferably, the system operates continuously.

The invention also relates to a method for treating, handling or purifying in-door air in a building having a plurality of rooms. The method for treating air in the building 2 may comprise the steps outlined below.

Step 1. Providing an air flow through the series of subsequent rooms using the fan units disposed in opening in the walls that separate the rooms, such that air is transported from a first room through the series of rooms to a last room and then back to the first room.

Step 2. Treating the air that is being transported through the building in order to improve the quality of one or more properties in the in-door air. The at least one air treatment device, such as the air handling unit, the air purifier or the filtering devices may be used for this purpose.

Step 3. Sensing a property of the air in order to determine the quality of the air. Predetermined levels of a property may be used for this purpose.

Step 4. Collecting data from the sensors. The radio units 22 and the server 20 may be used for this purpose. The collected data will indicate the measured value of an air property.

Step 5. Controlling the air flow based on the collected date. For example, if the measured value is above the predetermined value of the air property, a signal will be received by the server 20 and a commando will be sent by the server to the radio unit to change the speed and/or direction of the fan 6.

Examples of air properties that may be measured by the sensors are temperature and moisture, or gases, such as carbon monoxide, carbon dioxide, ozone, sulfur dioxide, nitrogen dioxide, smoke, or other gases, or particles, such as dust, seeds, plant spores, bacteria, viruses, fungi, mold, dust mite, smog, soot, water, and the like.

Atmospheric particles or other particles may be defined as particulate matter (PM) or particulates having a size of e.g. 2.5 micrometer (μm) (PM2.5). Official pollution reports in polluted area may include results of measured PM2.5 and PM10.

The system 1 of the invention is preferably capable of removing particles that endanger the health of the people present in the building. The system preferably removed particles in a size between 1 pm and 1 mm, or between 5 nm and 100 μm.

In one embodiment, the air treatment device 4 is adapted to remove small particles (having a size below 100 μm. The filters 4b are used to remove larger particles (having a size above 99 μm from the air.

### Experiment 1

An experiment was performed to test the system 1 according to the invention. The building, as shown in FIG. 3, comprises five rooms 3a, 3b, 3c, 3d, 3e and four fans. The air purifier is positioned in room 3a. The doors between the rooms were open during the experiment.

In the building, a thick fog of particles was distributed equally over all the rooms at a density of about 9000 μg/m³. The particle PM2.5 concentration was measured in room 3b using a particle sensor 7a.

Three different tests were performed.

Test 1. No fans on and no air purifier on.

Test 2. No fans on, but the air purifier on.

Test 3. Fans (without filters) on and air purifier on.

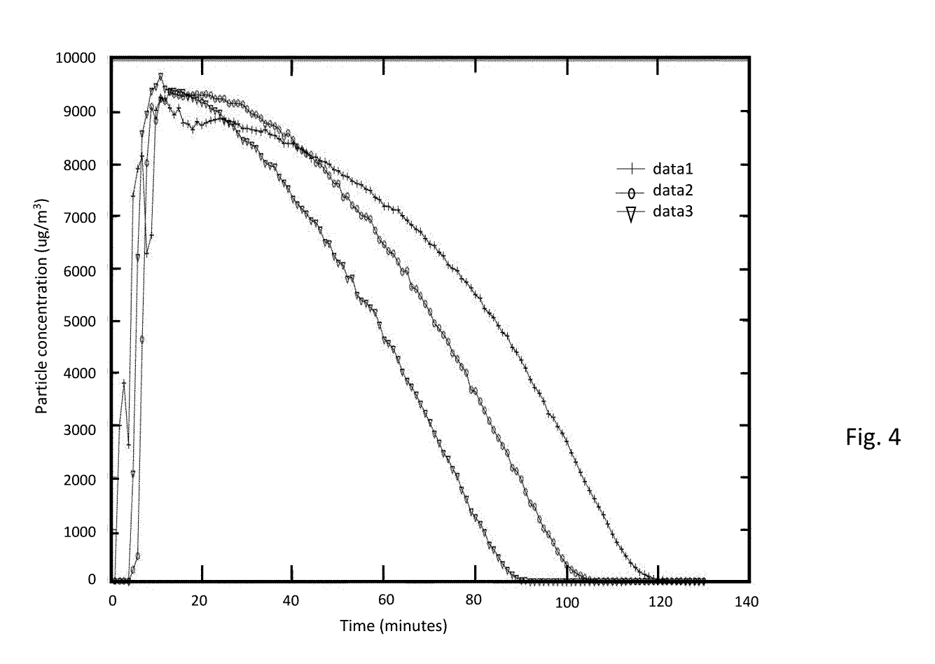

The results of the tests are shown in the graph of FIG. 4. The y-axis shows the particle PM2.5 concentration measured by the sensor 7a in room 3b. The x-axis shows the time in minutes.

Comparing the result of Test 2, data 2 to the result of Test 1, data 1, shows a 15 minute improvement for the removal of the air particles. Comparing the result of Test 3, data 3 to the result of Test 1, data 1, shows a 30 minute improvement for the removal of the air particles. Thus, the results clearly show that the air was cleaned quickest when both the fans and the air purifier were used (data 3 from Test 3). The differences between the results of Test 2 and Test 1 versus the differences between the results of Test 3 and Test 1 show a 100% improvement in treatment of air when both the air purifier and the fans are used.

From these results it follows that results, from an experiment in which filters would be used in the some or all the fan units, with or without simultaneous use of the air purifier, are expected to be the same or even better compared to the results obtained from Test 3. A possible pressure drop due to the position of the filters in the air flow passage way can easily be compensated by changing the speed of the fans.

The present invention is not limited to the embodiments disclosed but may be varied and modified within the scope of the following claims. For example, the housing of the fan units may have another shape, or some sensors may be positioned outside the housing in a different part of the rooms. Further, the air handling unit may be an apparatus that has more than one air quality changing function, e.g. heater/cooler, humidifier/dehumidifier, filtering the air and purifier.

1-20. (canceled)

21. A system (1) for control of in-door ventilation in a building (2) having a series of subsequent rooms (3) separated by walls, and a first room and a last room in the series of rooms are separated by one of the walls, whereby the system comprises:
at least one air treatment device (4b) arranged to treat the air in the building,
a plurality of fan units (5), wherein each fan unit includes a fan (6) and at least one sensor (7) for sensing at least one property of the air in the building, and
a central computing device (20) adapted to collect data from the sensors and to control the fans (6) based on the collected data, whereby each of the walls is provided with at least one opening, the fan units (5) are disposed in the openings in the walls to provide an air flow between subsequent rooms through the openings, whereby the fans are arranged such that the air is transported from the first room through the series of rooms to the last room and then back to the first room, and the air treatment device is disposed so that at least a part of the transported air is treated by the air treatment device, wherein the at least one air treatment device (4b) comprises a plurality of filtering devices (4b) and each of the fan units (5) is provided with one of said filtering device (4b), wherein each fan unit (5) comprises a tube shaped housing (9) and the fan (6) and the at least one sensor (7) are positioned inside the housing, and the system removes particles in a size between 1 pm and 1 mm, and no holes in walls to an outside of the building need to be drilled.

22. The system according to claim 21, wherein the at least one sensor is positioned on a side of the fan facing away from a side where air enters the fan unit.

23. The system (1) according to claim 21, wherein each wall that separates the rooms contains one fan unit (5).

24. The system according to claim 21, wherein the central computing device (20) is adapted to control the speed of the fan (6) based on the collected data.

25. The system according to claim 21, wherein said fan (6) is bidirectional and the central computing device (20) is adapted to control the direction of the fan (6) based on the collected data.

26. The system according to claim 21, wherein the at least one property of air is selected from the group comprising temperature, moisture, carbon monoxide, carbon dioxide, ozone, sulfur dioxide, nitrogen dioxide, smoke, soot, dust, seeds, plant spores, bacteria, fungi, mold, dust mite, smog and water.

27. The system according to claim 21, wherein the at least one sensor (7) is adapted for sensing at least one property related to the quality of the air passing through the fan (6).

28. The system according to claim 21, wherein at least one fan unit (5) further comprises a motion sensor (10).

29. The system according to claim 21, wherein each fan unit (5) comprises a radio unit (22) adapted to communicate with the central computing device (20).

30. The system according to claim 21, wherein the fan (6) and/or the at least one sensor (7) in each fan unit (5) can be turned on or off manually.

31. A system (1) for control of in-door ventilation in a building (2) having a series of subsequent rooms (3) separated by walls, and a first room and a last room in the series of rooms are separated by one of the walls, whereby the system comprises:
at least one air treatment device (4) arranged to treat the air in the building,
a plurality of fan units (5), wherein each fan unit includes a fan (6), and
a central computing device (20) adapted to control the fans (6), whereby each of the walls is provided with at least one opening, the fan units (5) are disposed in the openings in the walls to provide an air flow between subsequent rooms through the openings, whereby the fans are arranged such that the air is transported from the first room through the series of rooms to the last room and then back to the first room, and the air treatment device is disposed so that at least a part of the transported air is treated by the air treatment device,
wherein the at least one air treatment device (4b) comprises a plurality of filtering devices (4b) and each of the fan units (5) is provided with one of said filtering device (4b), wherein each fan unit (5) comprises a tube shaped housing (9) and the fan (6) and the at least one sensor (7) are positioned inside the housing, and the system removes particles in a size between 1 pm and 1 mm, and no holes in walls to an outside of the building need to be drilled.

32. A system (1) for control of in-door ventilation in a building (2) having a series of subsequent rooms (3) separated by walls, and a first room and a last room in the series of rooms are separated by one of the walls, whereby the system comprises:
at least one air treatment device (4) arranged to treat the air in the building, and
a plurality of fan units (5), wherein each fan unit includes a fan (6),
whereby each of the walls is provided with at least one opening, the fan units (5) are disposed in the openings in the walls to provide an air flow between subsequent rooms through the openings, whereby the fans are arranged such that the air is transported from the first room through the series of rooms to the last room and then back to the first room, and the air treatment device is disposed so that at least a part of the transported air is treated by the air treatment device,
wherein the at least one air treatment device (4b) comprises a plurality of filtering devices (4b) and each of the fan units (5) is provided with one of said filtering device (4b), wherein each fan unit (5) comprises a tube shaped housing (9) and the fan (6) and the at least one sensor (7) are positioned inside the housing, and the system removes particles in a size between 1 pm and 1 mm, and no holes in walls to an outside of the building need to be drilled.

33. The system according to claim 31, wherein the fan (6) in each fan unit (5) can be turned on or off manually.

34. A method for treating in-door air in a building (2) having a series of subsequent rooms (3) separated by walls, and a first room and a last room in the series of rooms are separated by one of the walls, wherein the method comprises the steps of:
providing an air flow through the building from the first room through a series of subsequent rooms to the last room and back to the first room by means of fans disposed in at least one opening per wall,
treating the transported air to improve the quality of the air by filtering air using a filtering device (4b) comprises a plurality of filtering devices (4b) and each of the fan units (5) is provided with one of said filtering device (4b), wherein each fan unit (5) comprises a tube shaped housing (9) and the fan (6) and the at least one sensor (7) are positioned inside the housing, and the system removes particles in a size between 1 pm and 1 mm,
sensing at least one property related to the quality of the air in the openings in the walls,
collecting data from the at least one sensor disposed in the opening, and
controlling the air flow based on data collected by a central computing device (20), and
no holes in walls to an outside of the building need to be drilled.

35. The system (1) according to claim 22, wherein each wall that separates the rooms contains one fan unit (5).

36. The system according to claim 22, wherein the central computing device (20) is adapted to control the speed of the fan (6) based on the collected data.

37. The system according to claim 23, wherein the central computing device (20) is adapted to control the speed of the fan (6) based on the collected data.

38. The system according to claim 22, wherein said fan (6) is bidirectional and the central computing device (20) is adapted to control the direction of the fan (6) based on the collected data.

39. The system according to claim 23, wherein said fan (6) is bidirectional and the central computing device (20) is adapted to control the direction of the fan (6) based on the collected data.

40. The system according to claim 24, wherein said fan (6) is bidirectional and the central computing device (20) is adapted to control the direction of the fan (6) based on the collected data.
